(19) United States
(12) Patent Application Publication
(10) Pub. No.: US 2005/0243009 A1
(43) Pub. Date: Nov. 3, 2005

(54) Omnidirectional broadband monopole antenna

(75) Inventors: Kin-Lu Wong, Kaohsiung (TW); Chia-Lun Tang, Miaoli County (TW); Saou-Wen Su, Taipei City (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 10/945,046

(22) Filed: Sep. 21, 2004

(30) Foreign Application Priority Data
Apr. 29, 2004 (TW) 093111988

(51) Int. Cl. H01Q 9/38

(52) U.S. Cl. 343/829

(57) ABSTRACT

An omnidirectional broadband monopole antenna comprises a ground plane, a radiating member, and a feed member. The ground plane is made of a metal plate. The radiating member comprises a first sub-radiating member, a second sub-radiating member connected to one side of the first sub-radiating member to provide a first angle therebetween, and a third radiating member connected to another side of the first sub-radiating member opposite the second sub-radiating member; a second angle is provided by the first and third sub-radiating members. The feed member is made of a metal rod with one end connected to the radiating member and the other to a signal source. Gain variations of the antenna's horizontal radiation pattern across the operating bandwidth are less than 3 dB.

### BACKGROUND

The present invention relates to a broadband monopole antenna, and in particular to an antenna with omnidirectional horizontal radiation.

For higher wireless transmission rates, a broadband antenna is popularly used, especially those capable of providing omnidirectional radiation. Recently, planar metal-plate monopole antennas are frequently used. Although frequency ratios over 1:3 are available, omnidirectional radiation characteristics (e.g. radiation pattern) thereof are unstable, generally decreasing with operating frequency. This behavior is mainly because, for achieving a very wide impedance bandwidth, the planar metal-plate monopole is usually designed to be with a large width, which is usually comparable to or larger than a quarter-wavelength of the highest operating frequency in the impedance bandwidth. In this case, due to the path-length difference caused by the large monopole width, the antenna's radiated fields contributed from the excited surface currents near the two side edges of the planar monopole will be destructive in the direction parallel to the planar monopole. On the other hand, the radiated fields in the direction normal to the planar monopole in general have no path-length difference and will be constructive. This behavior will lead to poor omnidirectional radiation characteristics for the conventional planar monopole antenna.

U.S. Pat. No. 4,466,003 discloses a conventional monopole antenna comprising several metal rods of various lengths creating various resonance frequencies. However, this monopole antenna is oversized and presents a complicated configuration.

A broadband monopole antenna disclosed in U.S. Pat. No. 5,828,340 increases 40% of the operation bandwidth, but cannot satisfy commercial requirement.

U.S. Pat. No. 6,339,409 discloses a helical antenna formed by a right-angle triangular conductive plate. Although wider bandwidth is available, this antenna presents an even more complicated structure.

### SUMMARY

Embodiments of the invention provide a broadband monopole antenna with gain variation in horizontal radiation pattern less than 3 dB across all operating frequencies in bandwidth thereof.

An omnidirectional broadband monopole antenna of embodiments of the invention comprises a ground plane with a via-hole, a radiating member disposed thereabove comprising a plurality of sub-radiating members to provide angles with a feed member connected to the radiating member.

The radiating member comprises a first sub-radiating member having a first side and a second side opposite thereto, a second sub-radiating member connected to the first side extending in a first direction, and a third sub-radiating member connected to the second side, extending in a second direction.

The angled configuration of the radiating member comprising the first, second, and third sub-radiating members is generated by bending a metal plate, or by combining at least two metal plates.

The feed member can be a metal rod with one end connected to a feed point on the first radiating member through a via-hole in the ground plane.

The first sub-radiating member and the second radiating member provide a first angle, and the first sub-radiating member and the third radiating member provide a second angle. By adjusting the first and second angles between 40° and 130°, gain variation of the horizontal radiation pattern can be less than 3 dB.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1a is a perspective view of an omnidirectional broadband monopole antenna of the first embodiment of the invention;

FIG. 1b is a front view of an omnidirectional broadband monopole antenna of a first embodiment of the invention;

FIG. 2 is a diagram of return loss of the omnidirectional broadband monopole antenna of the first embodiment of the invention;

FIG. 3a shows the radiation pattern in x-z plane (vertical plane) of the omnidirectional broadband monopole antenna of the first embodiment of the invention at 3 GHz;

FIG. 3b shows the radiation pattern in x-y (horizontal) plane of the omnidirectional broadband monopole antenna of the first embodiment of the invention at 3 GHz;

FIG. 3c shows the radiation pattern in y-z (vertical) plane of the omnidirectional broadband monopole antenna of the first embodiment of the invention at 3 GHz;

FIG. 4a shows the radiation pattern in x-z plane (another vertical) of the omnidirectional broadband monopole antenna of the first embodiment of the invention at 6 GHz;

FIG. 4b shows the radiation pattern in x-y (horizontal) plane of the omnidirectional broadband monopole antenna of the first embodiment of the invention at 6 GHz;

FIG. 4c shows the radiation pattern in y-z (vertical) plane of the omnidirectional broadband monopole antenna of the first embodiment of the invention at 6 GHz;

FIG. 5 is a gain diagram of the omnidirectional broadband monopole antenna of the first embodiment of the invention;

FIG. 6a is a perspective view of the omnidirectional broadband monopole antenna of a second embodiment of the invention;

FIG. 6b is a top view of the omnidirectional broadband monopole antenna of the second embodiment of the invention;

FIG. 7a is a perspective view of an omnidirectional broadband monopole antenna of a third embodiment of the invention; and

FIG. 7b is a top view of the omnidirectional broadband monopole antenna of the third embodiment of the invention.

### DETAILED DESCRIPTION

### First Embodiment

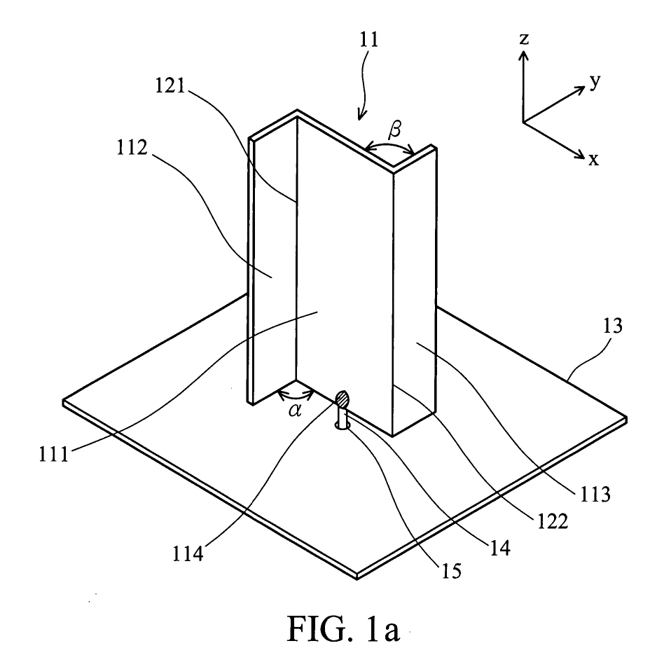

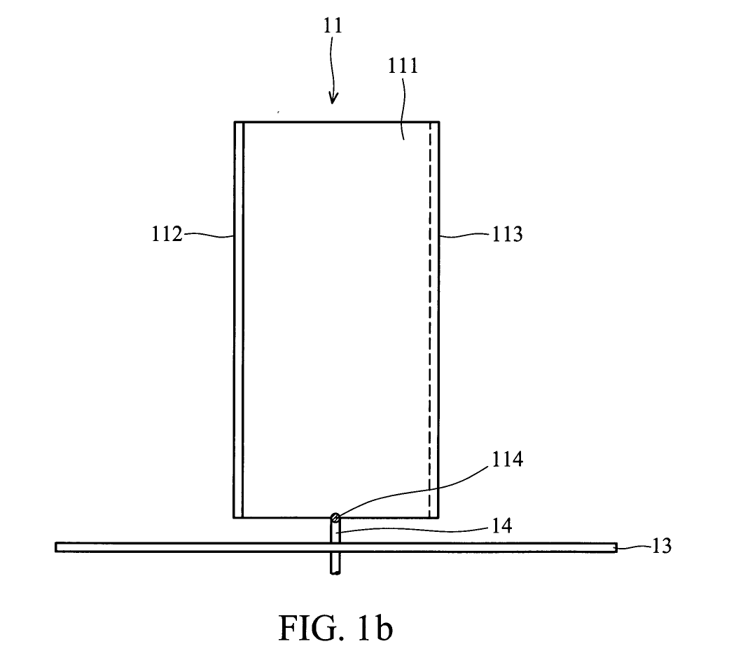

An omnidirectional broadband monopole antenna of the first embodiment of the invention is shown in FIGS. 1a and 1b, comprising a radiating member 11, a ground plane 13 and a feed member 14. The radiating member 11 comprises a first sub-radiating member 111, a second sub-radiating member 112 and a third sub-radiating member 113. The radiating member 11 has a first side 121 and a second side 122 opposite thereto. The second sub-radiating member 112 is connected to the first side 121, forming a first angle α. The third sub-radiating member 113 is connected to the second side 122, forming a second angle β substantially equal to the first angle α. Both the second and third sub-radiating members 112, 113 have the same planar shape, however, the second sub-radiating member 112 extends opposite to the third sub-radiating member 113.

The radiating member 11 can be formed by angling a metal plate to the configuration of the first, second and third sub-radiating members, or by combining (e.g. welding) two metal plates.

The ground plane 13 with a via-hole 15 comprises a metal plate. The feed member 14 is a metal rod with one end connected to a feed point 114 on the first sub-radiating member 111 via the via-hole 15 with the other end connecting to a signal source (not shown), without contacting the via-hole 15.

To obtain good omnidirectional radiation (gain variation in horizontal-plane radiation less than 3 dB), the first and second angles α and β are preferably between 40° and 130°. In this case the effective monopole width is greatly decreased, and thus the possible path-length difference caused by the monopole width is also greatly reduced. This behavior results in improved omnidirectional radiation for the proposed invention.

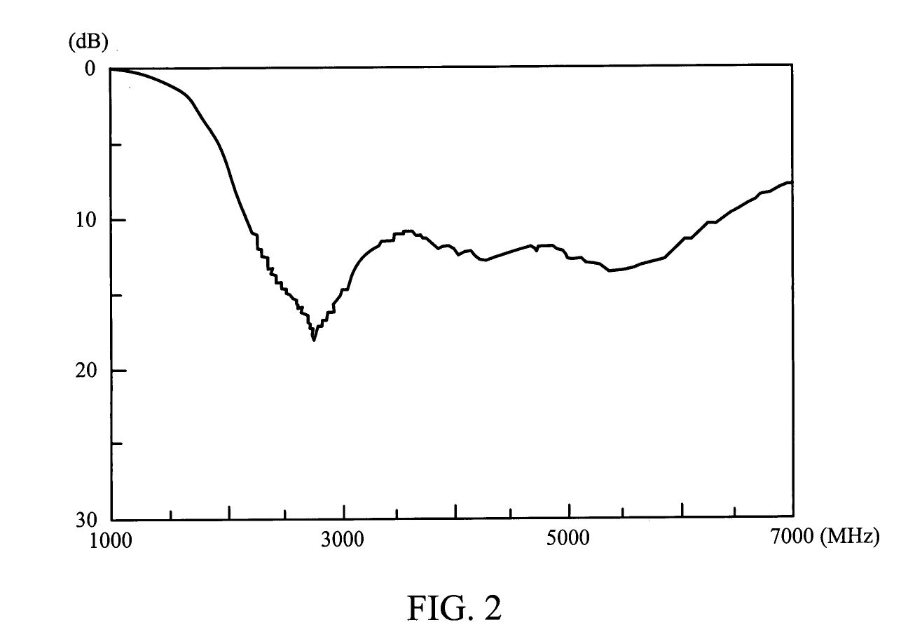

FIG. 2 shows return loss of the antenna of the embodiment. Vertical axis shows the return loss and horizontal operating frequency. Antenna size is determined by the rectangular first sub-radiating member 111 having length of 24 mm and width of 10 mm, rectangular second and third sub-radiating members having length of 24 mm and width of 5 mm, square ground plane having length of 100 mm with first and second angles of 90°. As shown in FIG. 2, with the bandwidth definition of 9.6 dB return loss (2:1 VSWR), the obtained impedance bandwidth ranges from 2.2 to 6.6 GHz (frequency ratio 1:3).

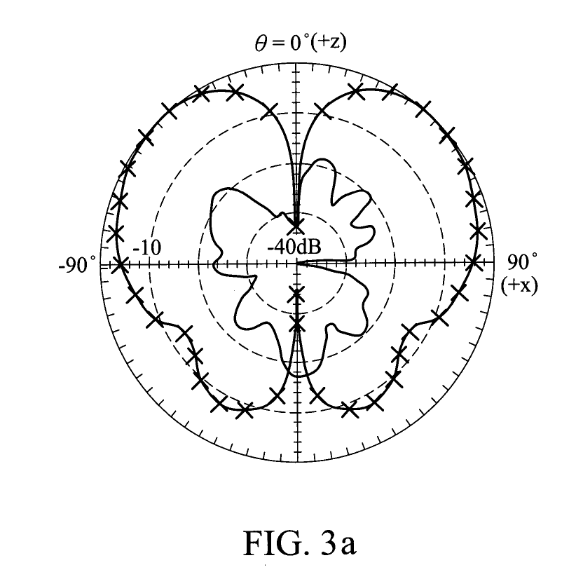

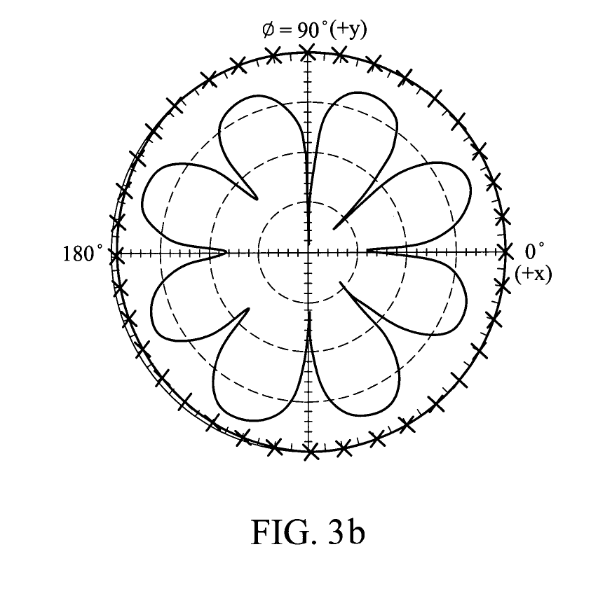

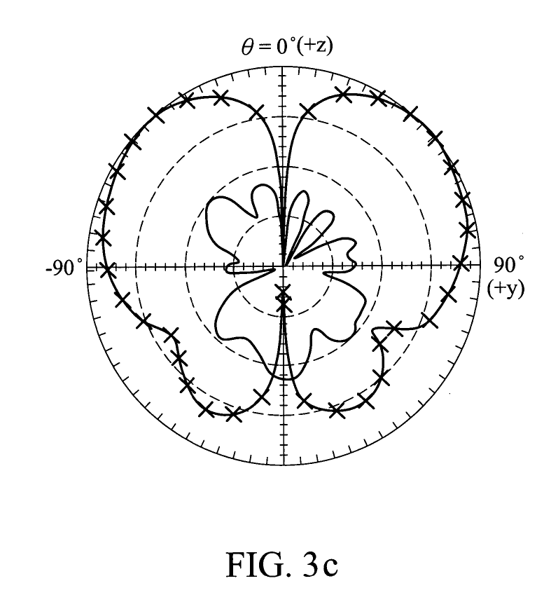

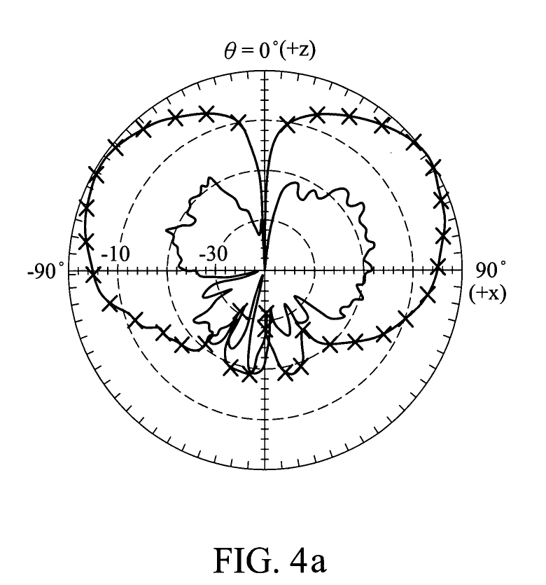

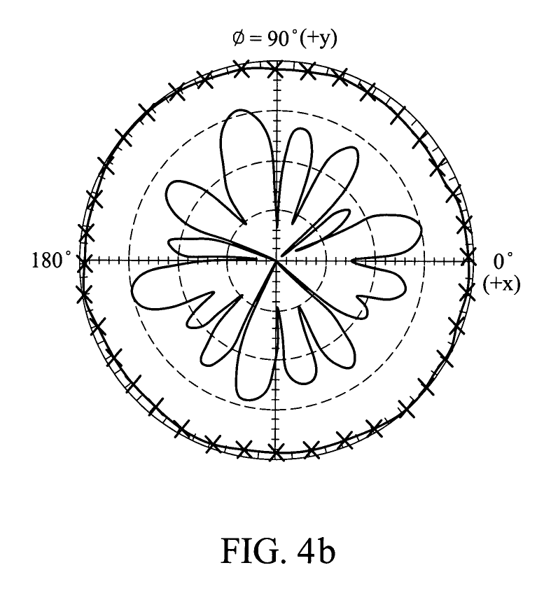

FIGS. 3a to 3c and 4a to 4c are radiation patterns of the omnidirectional broadband monopole antenna of the embodiment at 3000 MHz (3 GHz) and 6000 MHZ (6 GHz). θ represents angle with z axis, and φ the corresponding angle with x axis in the x-y plane. FIGS. 3b and 4b show radiation patterns measured in the x-y plane. In FIGS. 3b and 4b, gain variation of the radiation patterns is less than 3 dB. It was also found that, when the first and second angles are between 40° and 130°, the antenna of the invention exhibits a gain variation of horizontal radiation pattern less than 3 dB within the operating frequency range thereof.

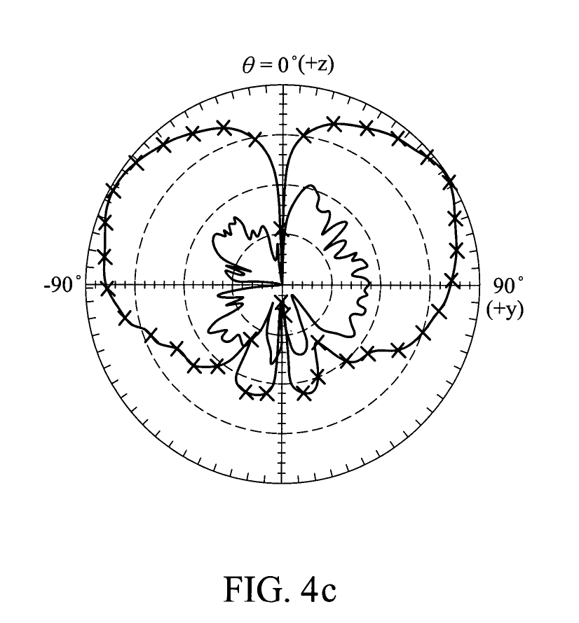

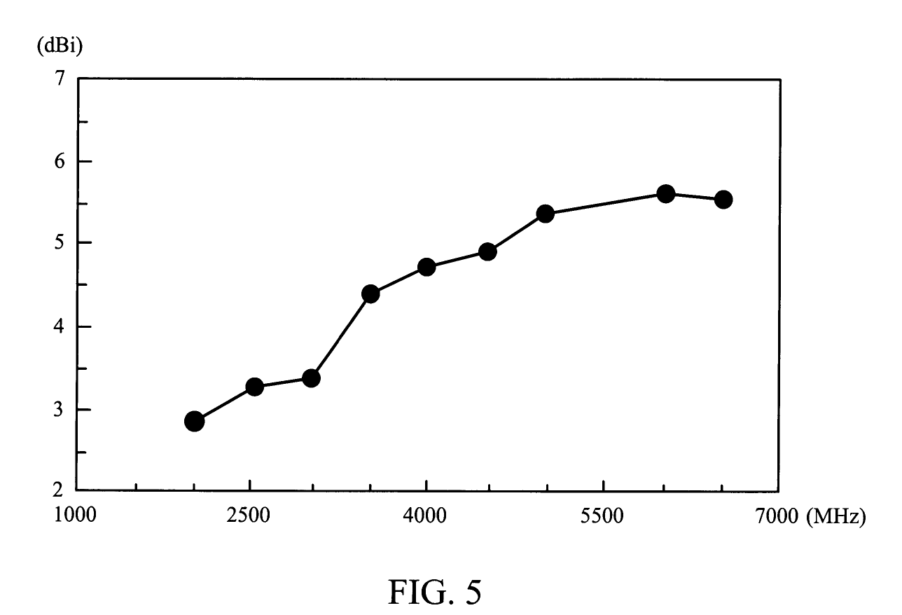

FIG. 5 shows the measured gain of the antenna of the embodiment. The measured gain within the operating frequency band ranges from 2.8 to 5.5 dBi, satisfying the requirement for wireless local area network communications.

### Second Embodiment

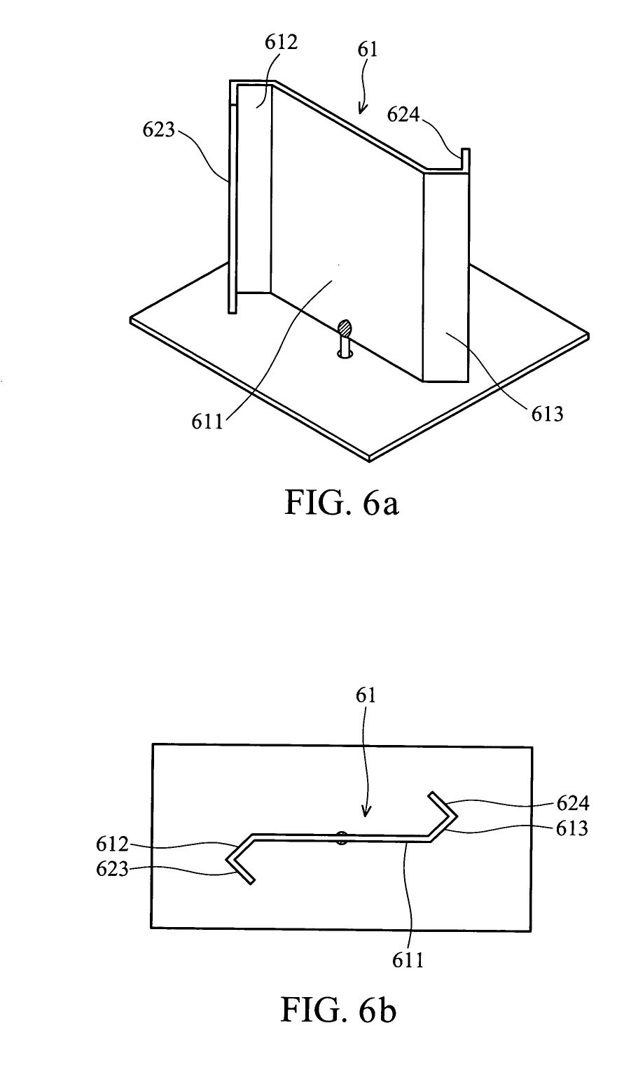

FIGS. 6a and 6b show the second embodiment of the omnidirectional broadband monopole antenna of the invention. The antenna in FIG. 6a comprises a first sub-radiating member 611, a second sub-radiating member 612, a third sub-radiating member 613, a fourth sub-radiating member 623 connected to the second sub-radiating member 612 and a fifth sub-radiating member 624 connected to the third sub-radiating member 613. The fourth sub-radiating member 623 extends opposite to the fifth sub-radiating member 624. In FIG. 6b, the fourth sub-radiating member 623 has the same planar shape as the fifth sub-radiating member 624. The sub-radiating members of this embodiment can be formed by angling a metal plate or by connecting two metal plates.

### Third Embodiment

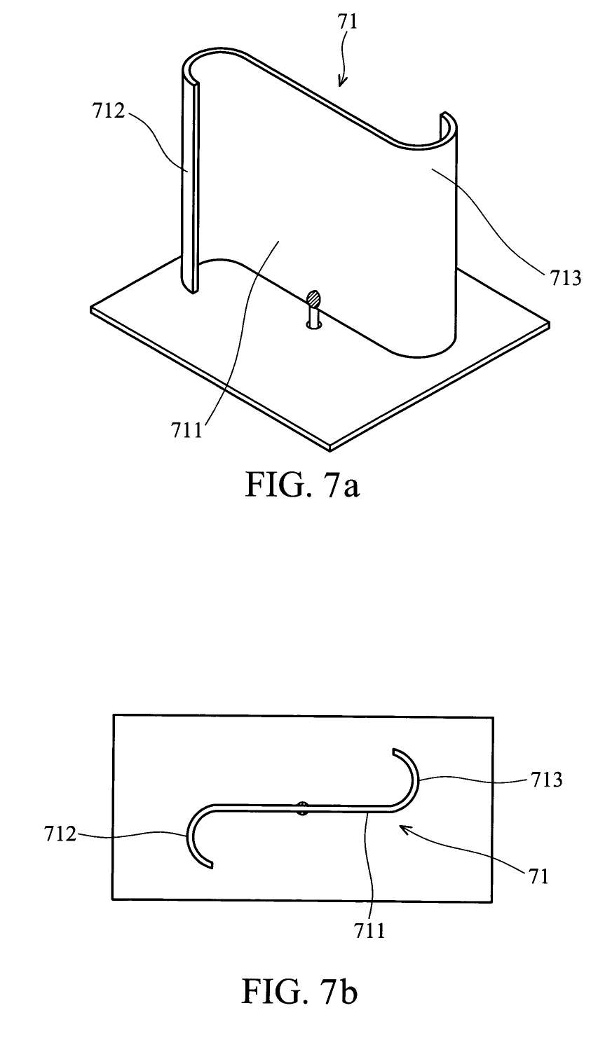

FIGS. 7a, 7b show the third embodiment of the omnidirectional broadband monopole antenna of the invention. The antenna of this embodiment comprises a curved second sub-radiating member 712 and a curved third sub-radiating member 713. Other components of the antenna in FIGS. 7a, 7b are the same as the antenna in FIG. 1.

The antenna of embodiments of the invention can provide simpler manufacture and improved horizontal omnidirectional radiation pattern, for broad application in commercial communication.

While the invention has been described by way of example and in terms of the preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An omnidirectional broadband monopole antenna, comprising:
a ground plane having a via-hole;
a radiating member disposed above the ground plane and comprising a plurality of sub-radiating members to provide angles; and
a feed member connected to the radiating member.

2. The omnidirectional broadband monopole antenna as claimed in claim 1, wherein the radiating member comprises:
a first sub-radiating member comprising a first side and a second side opposite thereto;
a second sub-radiating member connected to the first side and extending in a first direction; and
a third sub-radiating member connected to the second side and extending in a second direction.

3. The omnidirectional broadband monopole antenna as claimed in claim 2, wherein the second sub-radiating member and the third sub-radiating member are of the same shape.

4. The omnidirectional broadband monopole antenna as claimed in claim 2, wherein the first, second and third sub-radiating members are planar.

5. The omnidirectional broadband monopole antenna as claimed in claim 2, wherein a metal plate forms the first, second and third sub-radiating member.

6. The omnidirectional broadband monopole antenna as claimed in claim 3, wherein a metal plate forms the first, second and third sub-radiating member.

7. The omnidirectional broadband monopole antenna as claimed in claim 2, wherein at least two metal plates form the first, second and third sub-radiating member.

8. The omnidirectional broadband monopole antenna as claimed in claim 2, wherein the first sub-radiating member is wider than the second sub-radiating member.

9. The omnidirectional broadband monopole antenna as claimed in claim 2, wherein the first sub-radiating member is wider than the third sub-radiating member.

10. The omnidirectional broadband monopole antenna as claimed in claim 2, wherein the first sub-radiating member and the second radiating member provide a first angle between 40° and 130°.

11. The omnidirectional broadband monopole antenna as claimed in claim 2, wherein the first sub-radiating member and the third radiating member provide a second angle between 40° and 130°.

12. The omnidirectional broadband monopole antenna as claimed in claim 2, wherein the first sub-radiating member further comprises a feed point and the feed member comprises a metal rod with one end connected to the feed point through the via-hole.

13. The omnidirectional broadband monopole antenna as claimed in claim 2, wherein the radiating member further comprises a fourth sub-radiating member extending from the second sub-radiating member in a third direction and a fifth sub-radiating member extending from the third sub-radiating member in a fourth direction.

14. The omnidirectional broadband monopole antenna as claimed in claim 13, wherein the third direction is opposite to the fourth direction.

15. The omnidirectional broadband monopole antenna as claimed in claim 13, wherein the fourth and fifth sub-radiating members are planar.

16. The omnidirectional broadband monopole antenna as claimed in claim 13, wherein a metal plate provide the first, second, third, fourth and fifth sub-radiating member.

17. The omnidirectional broadband monopole antenna as claimed in claim 13, wherein at least two metal plates provide the first, second, third, fourth and fifth sub-radiating member.

18. The omnidirectional broadband monopole antenna as claimed in claim 1, wherein the ground plane is flat.

19. The omnidirectional broadband monopole antenna as claimed in claim 2, wherein the first direction is opposite to the second direction.

20. The omnidirectional broadband monopole antenna as claimed in claim 2, wherein the second and third sub-radiating members are curved.
